(19) United States
(12) Patent Application Publication
(10) Pub. No.: US 2026/0010889 A1
(43) Pub. Date: Jan. 8, 2026

(54) UNICARD SYSTEM AND METHOD OF USE

(71) Applicant: James Van Houten, Great Meadows, NJ (US)

(72) Inventor: James Van Houten, Great Meadows, NJ (US)

(21) Appl. No.: 19/047,108

(22) Filed: Feb. 6, 2025

Related U.S. Application Data
(60) Provisional application No. 63/666,876, filed on Jul. 2, 2024.

(51) Int. Cl. G06Q 20/22

(52) U.S. Cl. CPC G06Q 20/227

(57) ABSTRACT

A universal credit card system and method of use include the establishment of a partnership between entities from various industries for the implementation and execution of an agreement for a universal credit card specific to a group of consumers or a particular demographic. The universal credit card is not exclusively or majoritively owned by a bank or other financial institution. The agreement details the incentives (any form), membership parameters, and all expenses, utilities, IDs, and insurances capable of being managed on the single universal credit card.

### CROSS-REFERENCE TO RELATED APPLICATIONS

This application claims benefit under 35 U.S.C. § 119 (e) to U.S. Provisional Patent Application No. 63/666,876, filed Jul. 2, 2024, which is incorporated by reference herein in its entirety.

### BACKGROUND OF THE INVENTION

### Field of the Invention

The present invention relates to a universal credit card, more particularly, to a system and method of organizing a partnership between various entities from a multitude of industries, not exclusively or majoritively owned by a bank or other financial institution, to deliver greater incentives to end users.

### Related Art

With credit cards reaching interest rates as high as 36% APR, consumers are struggling to find value in utilizing these ticking time bombs. The old adage of “if you don't have it, don't spend it” becomes all too real as consumers are relying on credit cards for daily purchases, both big and small, and are getting hit with extremely high interest once these bills are due, and subsequently past due.

Interest rates for loans, credit cards, etc., typically depend upon the consumer's credit score. The lower a consumer's credit score, the higher the interest rate on the credit card or loan offered by the bank or financial institution.

The more risk the bank or financial institution exposes themselves to, the higher the penalty (through higher APR) the consumer is subjected to if payment is not received.

Minimizing the motivations for credit card use further, the cash-back and incentives offered by current credit cards are “watered down” as they are siphoned through the credit card companies before reaching the consumers.

Current credit cards are exclusively owned by banks or financial institutions, and the only incentives offered are decided and delivered exclusively through these entities. This means that if a company wants to offer an incentive for the use of a credit card at their store, they must get approval from the bank or financial institution administering/owning the card before the incentive is offered.

### BRIEF SUMMARY OF THE INVENTION

The present invention meets the above-identified needs by providing a means for consumers to safely charge any purchase to a lower APR credit card. This invention utilizes an ownership structure that eliminates the typical exclusive bank/financial institution-owned credit card and replaces it with a partnership between any number of entities, offering any number of incentives coming directly from those participating entities, all within a credit card that limits the risk to all participating entities (owners), thereby decreasing the overall APR for the consumer.

### BRIEF DESCRIPTION OF THE DRAWINGS

The novel features of the embodiments of the present application are outlined below. The embodiments themselves, as well as a preferred mode of use, and further objectives and advantages thereof, will best be understood by reference to the following detailed description when read in conjunction with the accompanying drawings, wherein:

FIG. 1 is a flowchart of the preferred system and method of use in accordance with a preferred embodiment of the present application; and

FIG. 2 is a matrix of the preferred system and method of use in accordance with a preferred embodiment of the present application.

While the system and method of use of the present application are susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application.

### DETAILED DESCRIPTION OF THE INVENTION

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such development effort might be complex and time-consuming but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

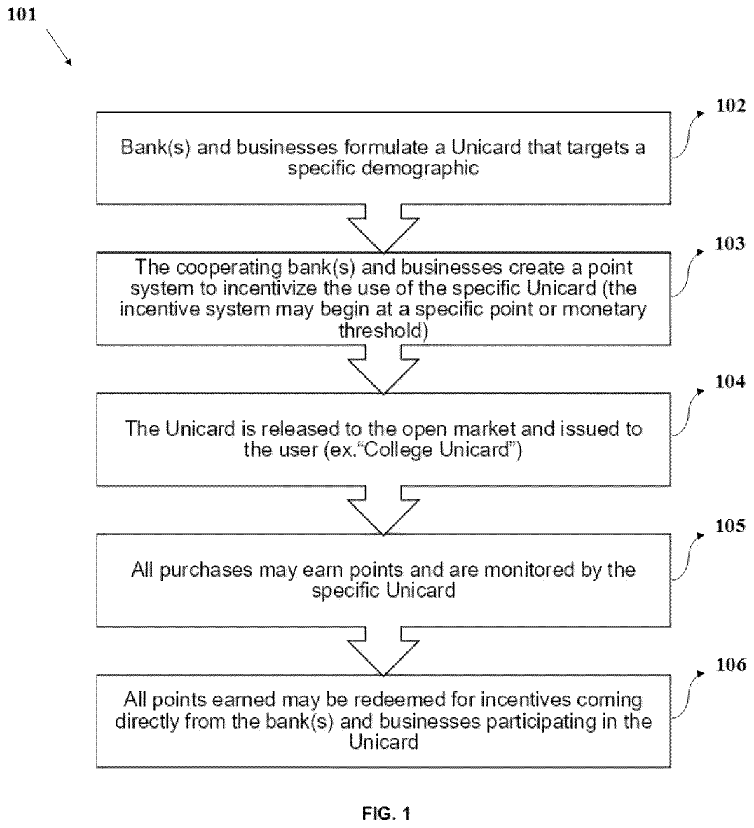

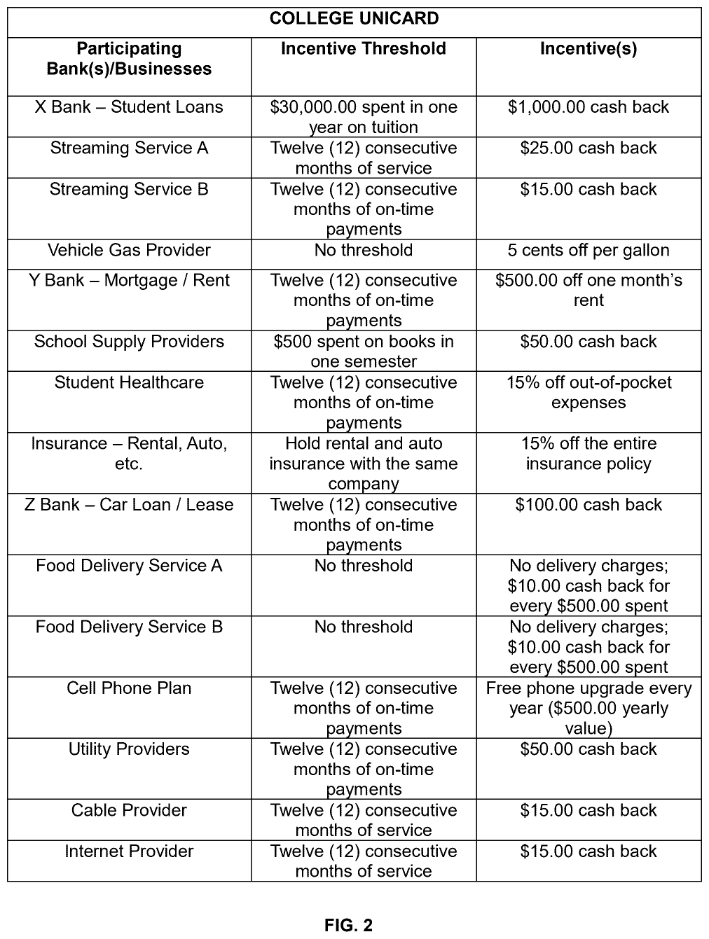

Referring now to the drawings wherein like reference characters identify corresponding or similar elements. FIGS. 1 and 2 depict a flowchart and a matrix of the system and method of use in accordance with the preferred embodiment of the present invention.

FIG. 1 is a flowchart of the preferred method of use in accordance with one desired system and method of use. Flowchart 101 includes a plurality of steps to achieve the desired results. In the present invention, the system and method of use can be used in any forum, business, or industry, and cannot be duplicated in any way.

In the preferred embodiment, it is desired to have a universal credit card designed to aid a specific demographic through the cooperation of demographic-specific businesses. This step is shown in 102 of the flowchart.

The chart in FIG. 2 is a sample chart of a matrix. It can contain unlimited rows and columns based on the needs of the particular agreement between the banks and participating businesses. It is believed that the discussion between the participating parties would involve negotiating percentages of profit and duties assigned.

The matrix may contain unlimited bracketed fields. An example of a matrix is found in FIG. 2. For example, the matrix would list individual names and their corresponding groups, the number of points received, the threshold needed to begin earning points, and the incentives that correspond to the points earned.

In a traditional rewards credit card marketed towards a specific group, the credit card companies own the credit card and utilize the fees and interest collected from merchants and consumers to fund their rewards programs. Therefore, the more interest you pay, the less the rewards are worth. For Unicard, banks and businesses formulate an actual rewards program where the savings come directly from the businesses and are not funneled through the credit card company. This difference between Unicard and a traditional credit card rewards program stems from the ownership of the credit card. For Unicard, no entity independently owns the specific Unicard; instead, the banks and businesses work together to offer a credit card that includes incentives that come directly from the businesses participating in the Unicard. For example, if there was a “Hunters Unicard”, outdoor sporting equipment retailers would work directly with the other participating businesses to negotiate rewards. This would equate to a greater “money-spent” to rewards conversion rate as the rewards would go directly from the retailer to the consumer and would not get funneled through the credit card company rewards program.

Banks and businesses would work to create a Unicard that targets a specific demographic 102. These specific demographics consist of users that exist as individuals, companies, businesses, organizations, etc. In one embodiment, a “College Unicard” may be formulated which creates a student-friendly cooperation between student-specific businesses. For example, streaming services, food delivery services, online product marketplaces, health insurance, rental insurance, car insurance, car loan payments, college tuition, books, etc., may all be included on one credit card (FIG. 2).

The incentive for users is that their bills and expenses may be organized on one platform while delivering incentives on the whole instead of expense by expense. Meaning, that if the user's expenses are all on one card, they will receive more incentives than if these expenses were distributed across many cards and accounts.

Additionally, the use of Unicard will create competition between businesses to produce the best Unicard with the best incentives, a benefit to the user. As discussed above, one major bank may establish its own “College Unicard”, which incorporates a multitude of student-specific businesses. At the same time, a competitor may establish a similarly identical card, but the competitor's card provides free financial advice with a trained professional upon graduation. This additional incentive may be enough to drive students to the competitor's “College Unicard”, which may also drive competing banks to increase their incentives, both of which benefit students.

Businesses would be incentivized to join a Unicard program because users would be more likely to engage Unicard-participating businesses over non-Unicard-participating businesses. For example, if a student has the “College Unicard” and is seeking to purchase a new car, they will be more likely to choose a car loan with a participating “College Unicard” bank than one outside of the card's limits. This will drive more consumers to the Unicard-participating bank than to a non-participating competitor.

Unicard can be used for all types of insurance programs, including Government-funded insurance programs. In one embodiment, the consumer would receive this Unicard and use it for proof of medical insurance and a means of paying utilities, mortgages, groceries, etc. The program would turn dollar purchases into incentives. These incentives would be negotiated by the banks and businesses participating in the program 103. For example, 1 dollar spent could be equivalent to 1 point. These points could then be redeemed for incentives, as depicted in 106 of the flowchart.

It is believed that this process would change a normal credit card into a universal credit card (Unicard), which may be tailored to specific demographics and be used at various businesses in various industries with the capability of accumulating points calculated on a matrix chart every month, leading to incentives. The purchases/points can be recorded and listed on the matrix chart, leading to user incentives, as illustrated in 105.

It is believed that the principal idea of the present invention is to benefit all individuals with a new universal credit card (Unicard) that may provide cash-back, discounts on their insurance premiums, and reward points on purchases to redeem for incentives. Banks and businesses may formulate specific Unicard programs that match incentives to specific demographics, offering incentives more specific to the targeted group. These groups can be as small or large as negotiated by the participating companies. This may take the form of groups of members with a specific credit score or members who are employed in a specific trade. Additionally, these groups may require a specific minimum standard for entry; for example, maintaining a credit score of 750+, spending $10,000.00 per month, or retaining membership in a particular organization or group 103.

Another possible incentive for participation in a specific Unicard could be yearly payouts made directly to users. These payouts may materialize into cash-back originating from each bank or business involved in the specific Unicard and may be negotiated by all parties involved. For instance, a “College Unicard” (FIG. 2) may incentivize $2,000.00 cash back if the user spends more than $30,000.00 a year on school-related expenses. The $2,000.00 may be generated from the cooperation between all school-related banks and businesses involved in the “College Unicard.” Additionally, the user could also receive a smaller cash-back amount; for instance, $25.00 for subscribing to a singular streaming service for twelve (12) straight months. Overall, each bank or business could have its own or unified incentive cash-back formula where the end-user collects directly from the banks and businesses that they frequent.

Participation in this form of Unicard may be subject to a minimum spending amount (i.e., $1,000.00 per month) and a mandated duration (i.e., active participation for a full year). Incentives in the form of payouts could also be distributed throughout the year to each active Unicard member.

Another example of this program could be savings for seniors. Specifically, Unicard could work with insurance companies (health, life, auto, etc.), banks (mortgages), and senior-specific retail businesses, to offer demographic-specific incentives. This may take the form of higher savings on prescriptions and discounted rates for car insurance. All incentives may be based on points earned through the use of Unicard.

In one embodiment, the points may not be accumulated until a specific monetary threshold is met. For example, in a group containing individuals with 750+ credit scores, the Unicard points may only begin accumulating once the individual spends $5,000.00. In another rendition of the program, the points may exponentially increase once the individual reaches a specific threshold. Meaning, for example, once the individual reaches $1,000.00, the accumulation of points begins; upon reaching $5,000.00 in spending, the individual would receive 2× the points for every purchase. The banks and the participating businesses would negotiate this method of distributing incentives 103.

Unicard could be issued by any bank or business (credit card company) 104. Unicard may be used for more than proof of insurance, it could be used for payments concerning deductibles, doctor visits, retail, and recurring bills.

The banks and participating businesses would negotiate all issues concerning this program like profit percentages, duties and responsibilities for each company, the impact on consumers, and compliance with all applicable rules and regulations.

The banks and participating businesses would keep records every time Unicard was utilized 105. This may then correspond to points 105 and eventually incentives for the consumer 106. For example, upon reaching a certain monetary threshold, a discount of anywhere from 0.5% to 1.5% could be applied to the consumer's healthcare premium or out-of-pocket expenses.

Unicard may offer the individual a credit loan from the individual's Unicard credit limit. This money could then be placed into the individual's checking or savings account. The individual can utilize this method for paying off higher-interest credit cards and as a direct result, save money. The bank/credit card company would assign an interest commensurate with how the applicant handled their finances, i.e., their credit score.

It is believed that Unicard would benefit the United States Government in that it would aid in preventing the investigation of fraud in the healthcare system. The Unicard program may take over all potential fraud or crime investigations because all credit card companies have investigation units and can investigate each incident more efficiently than the United States Government. The United States Government would save money, time, and effort as a direct result of the Unicard program. The United States Government currently averages ten (10) billion dollars annually investigating fraud within the Medicare program. Unicard would alleviate that burden.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments but are amendable to various changes and modifications without departing from the spirit thereof.

What is claimed is:

1. A universal credit card system and method of use, comprising:
forming a partnership to create a universal credit card between a conglomerate of entities in varying industries, not exclusively or majoritively owned by a bank or other financial institution, for the benefit of a group of consumers or a specific demographic; and
implementing and executing the universal credit card through agreements between the conglomerate of entities to deliver: (a) incentives produced by consumer use of the universal credit card, and (b) a universal credit card that provides a means to manage all expenses, utilities, IDs, and insurances on a single universal credit card.

2. The method recited in claim 1 wherein the partnership and agreements are negotiated between the conglomerate of entities.

3. The method recited in claim 1 wherein the agreements contain a list of membership parameters.

4. The method recited in claim 1 wherein the agreements contain the incentives and all expenses, utilities, IDs, and insurances capable of being managed on the single universal credit card.

5. The method recited in claim 1 wherein the incentives may take any form as determined by the partnership and agreements between the conglomerate of entities.
